(19) United States
(12) Patent Application Publication
(10) Pub. No.: US 2022/0361485 A1
(43) Pub. Date: Nov. 17, 2022

(54) INTERNALLY HEATED GEL REPELLENT

(71) Applicant: Lamplight Farms Incorporated, Menomonee Falls, WI (US)

(72) Inventors: Kyle Ressler, West Bend, WI (US); Lucas Henry Zeitler, Wauwatosa, WI (US)

(21) Appl. No.: 17/739,435

(22) Filed: May 9, 2022

Related U.S. Application Data
(60) Provisional application No. 63/186,051, filed on May 7, 2021.

(51) Int. Cl. A01N 25/06; A01N 37/36

(52) U.S. Cl. CPC A01N 25/06; A01N 37/36

(57) ABSTRACT

A system having a housing, an exothermic heater pack, and a gel carrier infused with an insect repellent. The housing retains the exothermic heater pack in sufficient proximity to the gel carrier infused with repellent that the repellent volatilizes from the gel carrier.

### CROSS-REFERENCE TO RELATED CASES

This application claims the benefit of U.S. provisional patent application Ser. No. 63/186,051, filed on May 7, 2021, and incorporates such provisional application by reference into this disclosure as if fully set out at this point.

### FIELD OF THE INVENTION

An insect repellent device. More particularly, the invention relates to a heating assembly container for containing a repellent infused gel, wherein a heat source material is carried by the heating assembly container and may be activated for volatilizing the repellent.

### BACKGROUND OF THE INVENTION

Insect repellents may be worn on the skin for repelling insects from an individual, or may be dispersed into the local atmosphere and work to repel insects from a localized area.

Repellents that are dispersed into the local atmosphere must have sufficient volatility when deployed to disperse into the atmosphere at levels at which they remain effective, but must not be so volatile as to rapidly exhaust themselves such that constant replenishment or an unworkable amount of product is needed. Volatilization of a repellent at a sufficient rate to be effective can also require the addition of a heat source to the repellent or repellent carrier.

What is needed is a composition, system, and/or method for addressing the above and related issues.

### SUMMARY OF THE INVENTION

The invention of the present disclosure, in one aspect thereof, comprises a system having a housing, an exothermic heater pack, and a gel carrier infused with an insect repellent. The housing retains the exothermic heater pack in sufficient proximity to the gel carrier infused with repellent that the repellent volatilizes from the gel carrier.

The insect repellent may comprise metofluthrin. The gel carrier may comprise isopropyl myristate. In some embodiments the exothermic heater pack contains a composition that produces heat upon exposure to air. In other embodiments, the exothermic heater pack contains a composition that produces heat upon exposure to water. In further embodiments, the exothermic heater pack contains two substances that produce heat when combined.

The exothermic heater pack may be integral with the gel carrier. The housing may comprise an upper housing portion and a lower housing portion that receives the exothermic heater pack integrated with the gel carrier. In some cases the upper housing portion opens from the lower housing portion to receive the exothermic heater pack integrated with the gel carrier, and contains a protrusion that punctures the exothermic heater pack when the housing is closed. They may also comprise a color changing heat indicator on the housing.

The invention of the present disclosure, in another aspect thereof, comprises a self-heating gel repellent insert having a first compartment containing a repellent gel carrier containing an insect repellent that volatilizes from the gel carrier when heated, and a second compartment containing a chemical based exothermic reactant for heating the gel carrier.

The chemical based exothermic reactant may produce heat upon exposure to air. In some cases the second compartment is punctured to activate the chemical based exothermic reactant. The gel repellent carrier may comprise isopropyl myristate. The repellent may comprise metofluthrin.

The invention of the present disclosure, in another aspect thereof, comprises an insect repellent system including a housing, a repellent contained in the housing, the repellent being volatilized by application of heat, and a chemical heater contained in the housing proximate the repellent.

The repellent contained in the housing may be imbued into a gel carrier having a first gel phase and a second liquid phase, the gel carrier releasing the repellent when in the second liquid phase. The gel carrier may comprise isopropyl myristate. The gel carrier may be retained within the housing by a polymer film.

In some embodiments, the housing has a first open position and a second closed position, and the housing mechanically activates the chemical heater by puncturing it when placed in the second closed position.

### BRIEF DESCRIPTION OF THE DRAWINGS

FIG. 1 is a perspective view of one embodiment of a gel repellent container according to aspects of the present disclosure.

FIG. 2 is a perspective view of another embodiment of a gel repellent container according to aspects of the present disclosure on a foil disk.

FIG. 3 is an elevation view of the gel repellent container of FIG. 2 received within a hanging heater apparatus.

FIG. 4 is a scatter plot of repellent volatilization rate versus temperature for some repellent gels of the present disclosure.

FIG. 5A is a perspective view of one embodiment an insect repellent system according to aspects of the present disclosure.

FIG. 5B is a side cutaway view of the insect repellent system of FIG. 5A.

FIG. 6A is a perspective view of another embodiment of an insect repellent system according to aspects of the present disclosure.

FIG. 6B is a side cutaway view of the insect repellent system of FIG. 6A.

FIG. 7A is a perspective view of another embodiment of an insect repellent system according to aspects of the present disclosure.

FIG. 7B is a side cutaway view of the insect repellent system of FIG. 7A.

FIG. 8A is a perspective view of another embodiment of an insect repellent system according to aspects of the present disclosure.

FIG. 8B is a perspective cutaway view of the insect repellent system of FIG. 8A.

FIG. 9 is a side cutaway view of another embodiment of insect repellent system according to aspects of the present disclosure.

FIG. 10A is a perspective view of another embodiment of an insect repellent system according to aspects of the present disclosure.

FIG. 10B is an exploded perspective view of the insect repellent system of FIG. 10A.

FIG. 11 is a perspective view of another embodiment of an insect repellent system according to aspects of the present disclosure.

FIG. 12A a perspective view of another embodiment of an insect repellent system according to aspects of the present disclosure.

FIG. 12B is a side cutaway view of the insect repellent system of FIG. 12A.

FIG. 13 is a scatter plot of repellent volatilization rate versus change in weight of some repellent gels of the present disclosure.

### DETAILED DESCRIPTION OF THE PREFERRED EMBODIMENTS

In various embodiments, the present disclosure provides for an insect repellent composition and system for outdoor recreational use. An insect repellent composition according to the present disclosure may comprise a repellent chemical such as pyrethrin, pyrethroids, metofluthrin, and/or another suitable repellent.

The repellent chemical may be infused into a gel carrier. By application of heat, the gel may release the repellent chemical. Stated another way, application of heat may allow the repellent chemical to diffuse or volatilize out of the gel and into the local atmosphere. The composition of the gel carrier, and the heat applied, may control the rate at which the repellent is volatilized and, in turn, the physical area and length of time over which the repellent chemical is active.

As explained further below, in some embodiments, compositions of the present disclosure remain in solid or gel form until heated, to induce a phase change. The composition may be a gel at room or ambient temperature and become a liquid when heat is applied. For purposes of the present disclosure, ambient temperature may be any temperature resulting from exposure to an indoor or natural environment, but without addition of heat or flame to the gel itself. For example, for purposes of the present disclosure, ambient temperature may range from below 0° C. to 45° C.

In the liquid form, compositions of the present disclosure may allow the repellent to disperse or volatilize into the atmosphere. Removal of heat can allow the liquid to return to solid or gel form, which stops or substantially minimizes volatilization of the chemical repellent remaining in the composition. Thus, unlike some other known compositions, compositions of the present disclosure can be partially used and then saved for further future use.

According to some embodiments, the gel carrier comprises a carrageenan or carrageenin. These substances are a family of natural linear sulfated polysaccharides that are extracted from red edible seaweeds. Carrageenans are widely used in the food industry, for their gelling, thickening, and stabilizing properties. Carrageenans are large, highly flexible molecules that form curling helical structures. This gives them the ability to form a variety of different gels at room temperature. All carrageenans are high-molecular-weight polysaccharides and mainly made up of alternating 3-linked b-D-galac-topyranose (G-units) and 4-linked a-D-galactopyranose (D-units) or 4-linked 3,6-anhydro-a-D-galactopyranose (DA-units), forming the disaccharide repeating unit of carrageenans.

In another embodiment, the gel carrier is high-purity synthetic isoparaffin solvent such as Isopar® available from ExxonMobile. An example composition based on Isopar® includes Isopar® M at 88% w/w, 8% w/w Rheostrux™ 100 (a rheology modifier available from Croda International), and 4% w/w metofluthrin (“w/w” being shorthand for “weight/weight”).

In another embodiment, the composition includes 88% w/w isopropyl myristate (IPM), 8% w/w Rheostrux™ 200, and 4% w/w metofluthrin. In another IPM based formulation, the composition includes 84% w/w IPM, 8% w/w Rheostrux™ 200, and 8% w/w metofluthrin.

In some embodiments, the composition consists only of those ingredients listed in specific examples. In other embodiments, other ingredients may be present. Other ingredients may include, without limitation, dyes, scents, and other admixtures.

Various methods may be utilized to produce the compositions detailed above. In one embodiment, IPM based compositions of the present disclosure may be produced as follows: 1) weigh Rheostrux™ 200 into a container; 2) add IPM to the container; 3) stir the resultant mixture under an applied heat of 150° C.; 4) at around 75° C. the composition becomes clear and colorless but additional stirring (e.g., 5 minutes or more) may increase/ensure homogeneity; 5) continue stirring, and allow the gel composition to cool to approximately 60° C. whereupon metofluthrin may be added. At about 50° C. (or higher) the composition can be poured into vessels or containers, where it will gel as it cools to ambient temperature. As is known on the art, colorants, dyes, scents or other admixtures can also be added.

Although the foregoing IPM based compositions are known to applicant to produce satisfactory results at 4% w/w metofluthrin and 8% w/w metofluthrin, other embodiments may comprise more or less metofluthrin, offset by correspondingly more or less IPM. In various embodiments, the metofluthrin ranges from about 4% w/w to about 16% w/w.

Application of heat to the formulated gel repellent compositions result in volatilization of the repellent and/or a phase change of the gel carrier (e.g., from solid or solid to liquid). With the gel carrier altered to a liquid form, volatilization of the repellent is readily achieved, while in gel form, little to no repellent is dispersed from the composition.

Various experiments were conducted utilizing the 4% w/w metofluthrin and the 8% w/w metofluthrin compositions discussed above. Various amounts of these compositions (weighing from about 1.5 grams to about 5 grams) were placed into shallow aluminum containers having a diameter of 4.5 cm. These were placed on hot plates of varying temperatures and the volatilization rate of the metofluthrin repellent in mg/hour was observed.

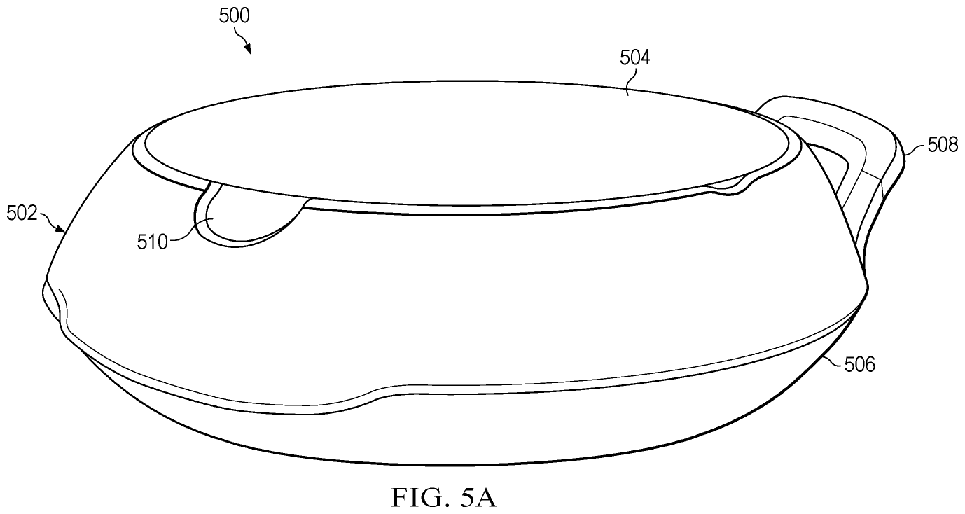

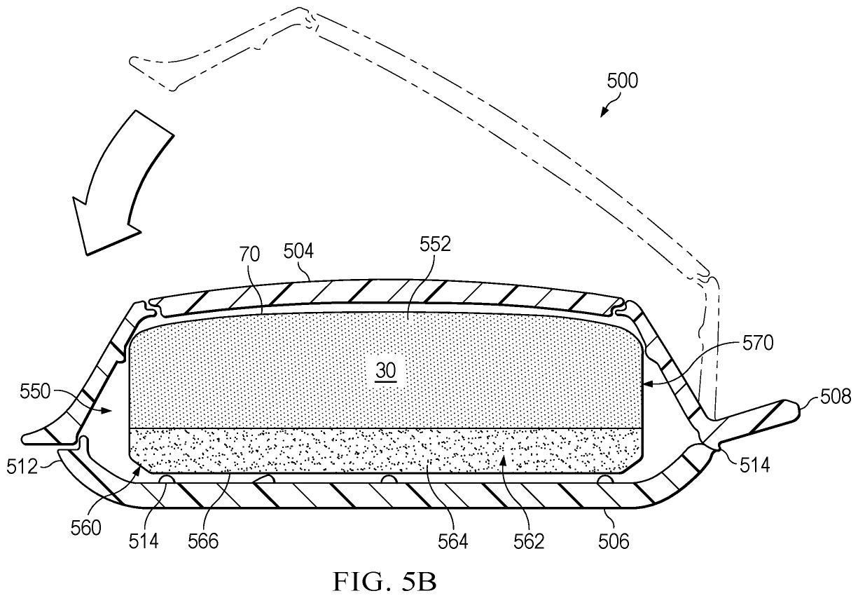

FIG. 5 summarizes the results of these experiments. It can be seen that the rate of volatilization or release of metofluthrin varies with temperature of the gel and with initial concentration of the repellent. 7-12 mg/hour of metofluthrin release is known to be sufficient for local repellency purposes. As can be seen, this is achievable with either the 4% w/w or the 8% w/w metofluthrin compositions. While effective repellence is achievable with 4%, 8% or other amounts of metofluthrin, the total amount of repellent is higher per volume or per unit weight in the higher concentration compositions. Thus increasing the concentration of metofluthrin (within limits that allows the gel carrier to operate satisfactorily) may prolong the usefulness of the composition at a given temperature.

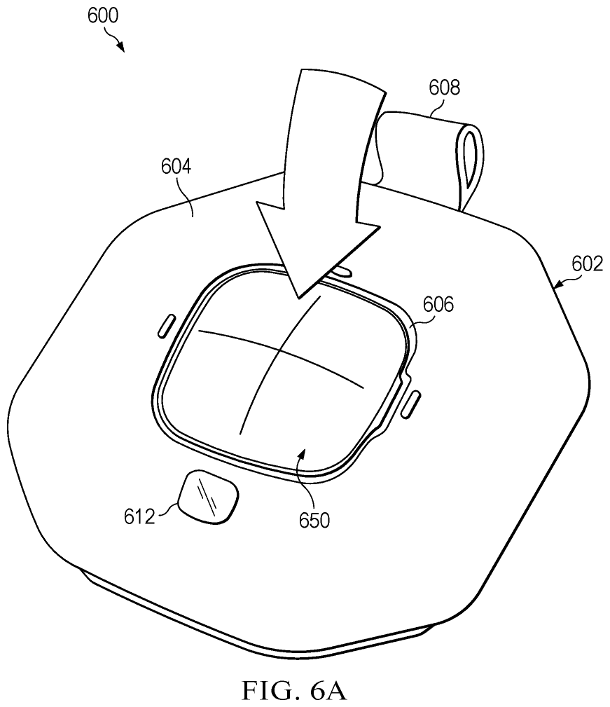

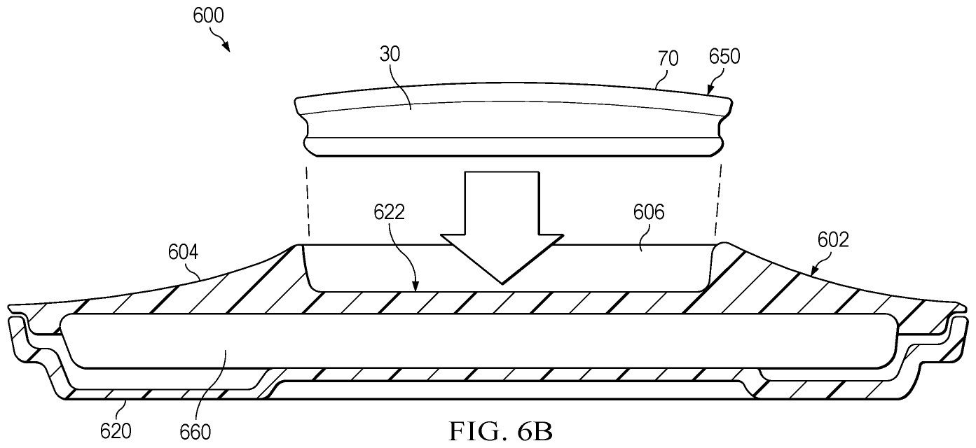

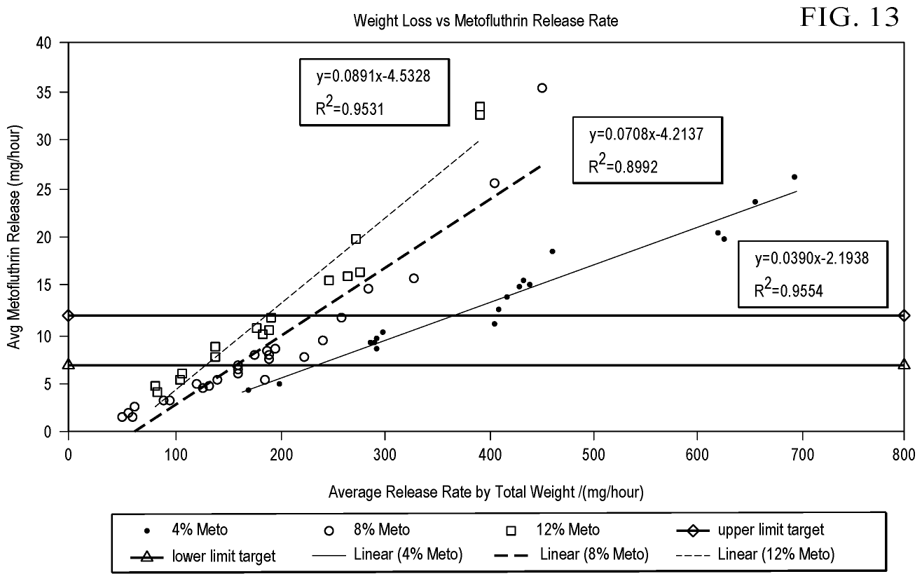

Referring now to FIG. 13, a scatter plot of repellent volatilization rate versus change in weight of some repellent gels of the present disclosure is shown. The data of FIG. 6 was based upon experimental determination of the release rate of metofluthrin versus the total weight lost from the gel carrier over the same time frame. As can be seen, the release rate of metofluthrin in mg/hour can be reliably correlated to the total loss of weight of the carrier gel in mg/hour. Thus, metofluthrin release rates can be assessed utilizing the loss in weight of the associated gel without the time and expense associated with complex equipment needed to analysis and quantify gases. This allows embodiments of the present disclosure to be easily tailored to a specific release rate of a repellent, particularly metofluthrin, in a straightforward fashion.

The repellent compositions of the present disclosure may be deployed in a wide variety of physical forms and with a wide variety of satisfactory heat sources. Potential heat sources include torches, fire pits, pellet heaters, propane pits, string lights, and electric heaters (operating from line voltage, battery, solar, etc.). Where the application includes potential exposure to open flame, the composition may be infused with flame retardants to resist or delay combustion.

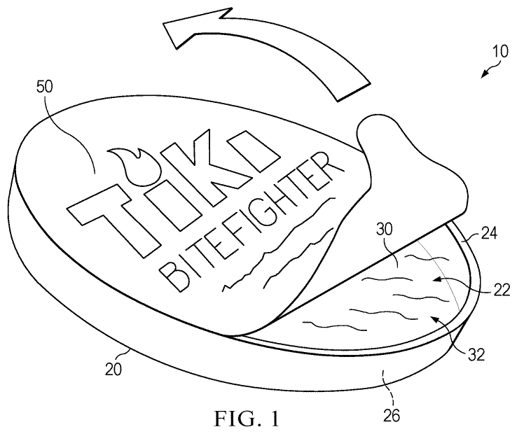

Referring now to FIG. 1 a perspective view of a repellent gel composition of the present disclosure deployed in a sealable container is shown. A packaged gel assembly 10 may include a container 20 defining an opening, cavity, or receptacle 22. The container 20 may have an open top 24 and a closed bottom 26. Gel 30 (representing a repellent gel composition according to the present disclosure) is received within receptacle 22 of container 20. The gel 30 may define an upper surface 32. The gel assembly 10 may also comprise a seal or sealing layer 50. The sealing layer 50 may comprise foil, polymer, a molded cap, or other implement. As discussed above, the gel 30 is composed such that when gel 30 is heated, gel 30 changes phase from a solid or gel phase to a liquid phase and volatilization of the repellent contained therein occurs. When gel 30 is allowed to cool, it changes phase again from a liquid phase to a gel phase. In the solid or gel phase, the gel 30 is stable, and little or no repellent is diffused therefrom.

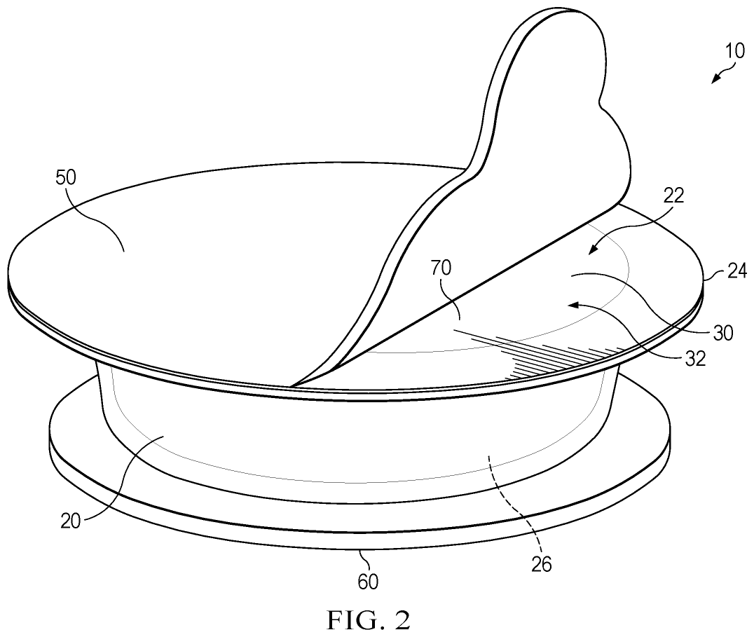

Referring now to FIG. 2 another perspective view the gel repellent assembly 10 according to aspects of the present disclosure is shown on a foil disk or plate 60. In one embodiment, plate 60 is affixed to closed bottom 26 of container 20 for evenly conducting heat from a heat source. In one embodiment, plate 60 is comprised of foil. A polymer film 70 may be located adjacent to upper surface 32 of gel 30. The polymer film 70 may be permeable by the volatilized repellent and allow diffusion of the same while preventing spillage or inadvertent contact with the gel 30, especially when the gel 30 has changed phase to liquid.

In one embodiment, polymer film 70 has a thickness of approximately 2 mil to 0.24 mil. For example, polymer film 70 may have a thickness of 2 mil, may have a thickness of 0.5 mil or may have a thickness of 0.24 mil. In one embodiment, polymer film 70 is a polypropylene film. The gel 30, with or without the polymer layer or film 70, can deliver a consistent release rate of repellent across a wide range of temperatures, e.g., from 75° C.-150° C.

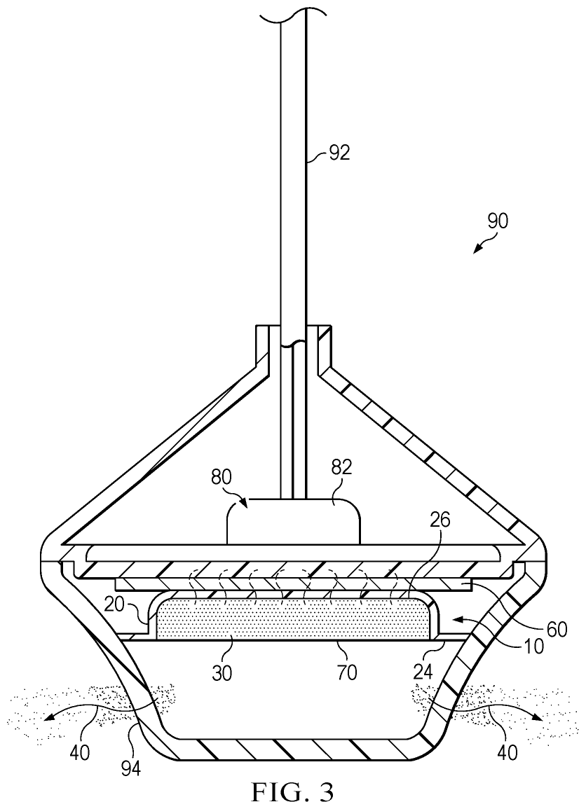

Referring now to FIG. 3 an elevation view of the gel repellent assembly 10 of FIG. 2 received within a hanging repellent delivery device 90 is shown. A heater 80 is provided for heating gel 30 for diffusing repellant 40. The heater 80 may comprise an electrically powered resistive heating element 82. In other apparatus, the heat source 80 may be replaced with an open flame or other heat source. The electrically heated heating element 82 may be incorporated within a repellent delivery device 90 suspended from an electric cord 92. Here, the repellent is diffused out the lower end of the delivery device 90 as shown by exemplary vapor path 40.

The system 90 is one employing what might be considered an “external” heat source. The heater 80 and its resistive heating element 82 are separate from the gel repellent container 20. A gel repellent assembly 10 in the system 90 may be replaced when exhausted, but the heating element 82 is generally retained and re-used. In other words, it is not considered a consumable item.

On the other hand “internal” heating mechanisms may also be used. In one example, a heater may be included as an integrated unit with a gel repellent container similar to gel repellent container 10 such that the heater becomes a consumable item as well. Such internal heating mechanism may be based on a number of technologies. Chemical based heaters may be used such as those relying on iron-air reactions and cells (similar to hand warmer technology), those activated by water such as magnesium oxidation system (similar to flameless ration heater technology), those based on the exothermic reaction of the curing of epoxies or similar.

In some embodiments, the exothermic reacting chemicals are not imbued into the gel carrier as the carrier itself tends to separate the reactants such that they do not react properly. Additionally, there is a need for a consumer to be able to start and possibly stop the reaction, which is difficult or impossible if the reactants are in the gel carrier. Therefore, in some embodiments, the exothermic reactants are packaged in a separate but integral compartment with the vessel containing the gel carrier.

Referring now to FIG. 5A, a perspective view of one embodiment an insect repellent system 500 according to aspects of the present disclosure is shown. The system 500 is shown inside cutaway in FIG. 5B. The system 500 may provide a housing 502 having an upper portion 504 hinged to a lower portion 506 via hinge 514. The two housing portions 504, 506 may define an interior cavity for receiving a self-heating repellent insert 550.

The self-heating repellent insert 550 may comprise an upper chamber 570 defining a cavity or space 552 that contains a quantity of repellent gel 30. A lower chamber 560 of the self-heating repellent insert 550 may define a space 562 containing a quantity of self-heating reactant 564 that becomes exothermic upon exposure to oxygen in the atmosphere. In some embodiments, the reactant 564 comprises iron filings for an iron-air reaction.

When the upper housing 504 is closed onto the lower housing portion 506, the fit of the self-heating repellent insert 550 is such that a lower wall 566 of the lower chamber 560 is punctured by protrusions 514 on the lower upper housing portion 506. Thus, a reaction with the reactant 564 produces heat that heats the gel 30 to promote volatilization of the repellent therein. Some embodiments provide an indicator window 510 that changes color when heated to a particular temperature to indicate that the self-heating repellent insert 550 is active.

The upper portion 504 of the housing 502 may latch to the lower housing portion 506 via latch 512 to retain the self-heating repellent insert 550. When the repellent in the gel 30 is exhausted and/or the reactant 564 no longer producing heat, the self-heating repellent insert 550 may be replaced.

In some embodiments, the self-heating repellent insert 550 is wrapped or partially or completely sealed prior to use. In some embodiments, a top portion of the upper chamber 570 is sealed with membrane 70 to allow repellent to escape but keep the gel 30 from spilling when it is in the liquid phase. Portions of the housing 502 may be perforated, porous, or otherwise ventilated both to admit oxygen for reaction with the reactants 562 and to disperse repellent. A hand tab 508 or other convenience features may also be provided.

Referring now to FIG. 6A, a perspective view of another embodiment of an insect repellent system according 600 to aspects of the present disclosure is shown. FIG. 6B is a side cutaway view of the insect repellent system 600 of FIG. 6A. Here, a repellent gel pack 650 is separate from an exothermic heater pack 660. These are retained by a housing 602 having an upper housing 604 defining a cavity 606 for receiving the repellent gel pack 650 may contain a repellent gel such as gel 30 discussed above. It may be ventilated or provided with a membrane 70 to allow volatilization of the repellent from the gel 30.

A lower housing 620 retains the exothermic heater pack, which may be based on any of the exothermic reactions disclosed herein or others known in the art. Where air is required for the exothermic reaction, a protrusion 622 may be provided on the upper housing 604 such that the exothermic heater pack 660 is punctured when the upper housing 602 and lower housing 620 are joined together. The upper housing 602 and lower housing 620 may join together via an interference fit and define a space between the two to accommodate the exothermic heater pack 660. A color changing heat indicator 612 may be present on the upper housing 602 or elsewhere.

The system 600 is considered self-heating although the exothermic heater pack 660 may be separate and separately replaceable from the gel repellent pack 650. Removal of either the heater pack 660 or the gel repellent pack 650 may halt the volatilization of the repellent from the gel 30 thereby allowing the system 600 to be used intermittently rather than using all of the repellent in the gel 30 at once.

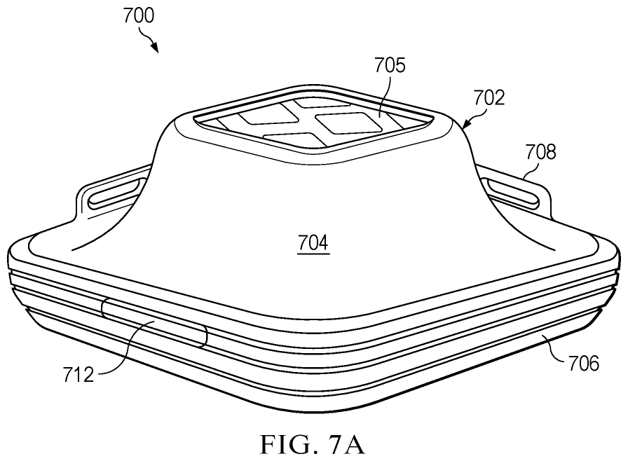

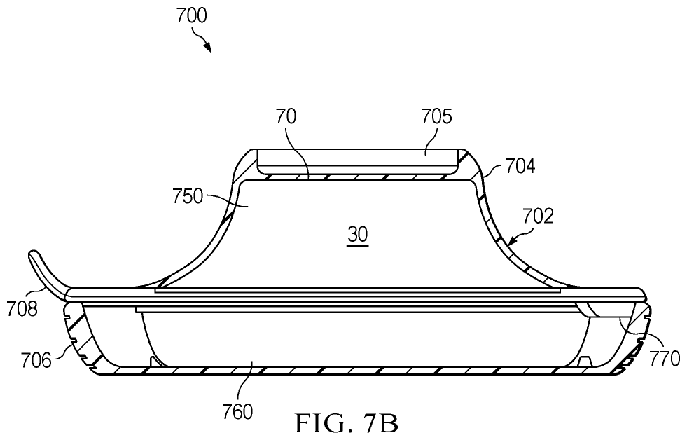

Referring now to FIG. 7A, a perspective view of another embodiment of an insect repellent system 700 according to aspects of the present disclosure is shown. FIG. 7B is a side cutaway view of the insect repellent system 700 of FIG. 7A. The system 700 is similar to the system 600 in that a repellent gel pack 30 may be provided separately from an exothermic heater pack 760.

A housing 702 has an upper housing 704 with a ventilated top 705 accommodating the repellent gel pack 750. A lower housing 706 accommodates the exothermic heater pack 760. The upper housing 704 may be rotated by a user with respect to the lower housing 706. When this occurs, the exothermic heater pack 760 is held by the lower housing 706 and a protrusion 770 affixed to the upper housing 704 punctures the exothermic heater pack allowing oxygen to enter and begin an exothermic reaction to heat the repellent gel pack 750.

The repellent system 700 may include a handle 708 on the upper housing 704 or other convenience features. A color changing indicator 712 (indicating heating) may be provided on the lower housing 706 or elsewhere.

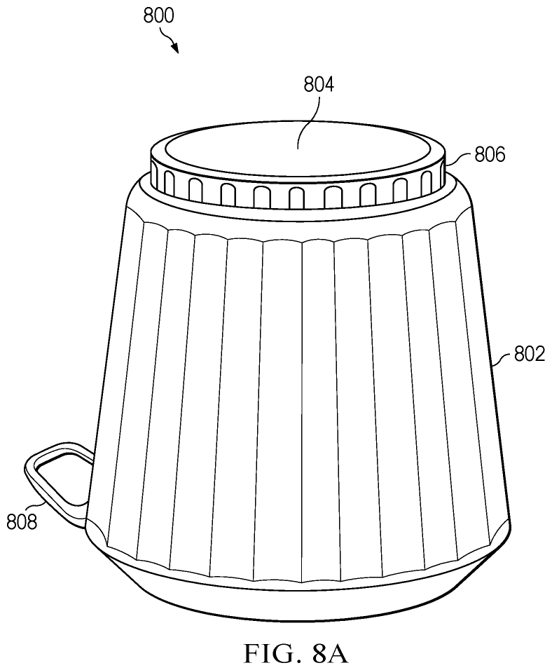

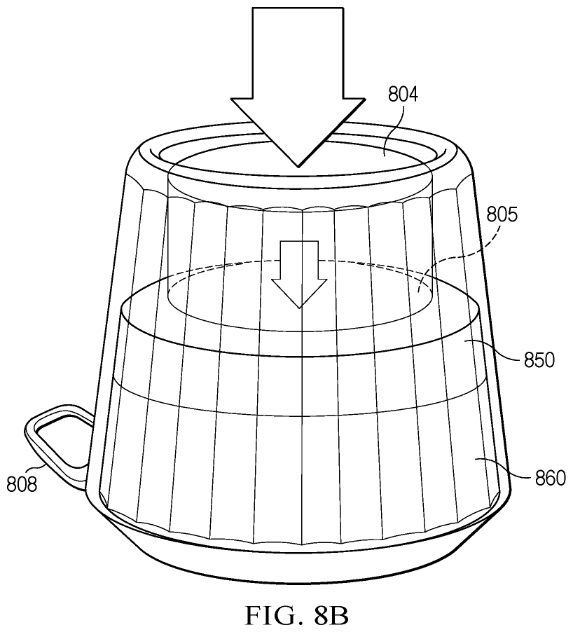

Referring now to FIG. 8A, a perspective view of another embodiment of an insect repellent system 800 according to aspects of the present disclosure is shown. FIG. 8B is a perspective cutaway view of the insect repellent system 800 of FIG. 8A. The system 800 comprises a housing with pop-up top 804 that provides ventilation openings 806 when open (as in FIG. 8A). When closed (FIG. 8B) the ventilation opening 806 of the top 804 are closed and may prevent sufficient oxygen from entering the housing to halt reaction of an internal exothermic heater pack 850.

The pop-up top 804 may extend from closed to open when pressed and released utilizing pop-open mechanisms are known in the art. Such mechanism also allows for reclosure of the top 804 by pressing again. The top 804 may also extend and retract via a threaded connection. For purposes of first use, the top 804 may have a lower end 805 with features to puncture the heater pack 860 (if it is provided sealed) to begin the exothermic reaction. In the present embodiment, a gel repellent pack 860 is below the heater pack 850. The gel repellent pack 860 and the heater pack 850 may or may not be provided as an integrated unit.

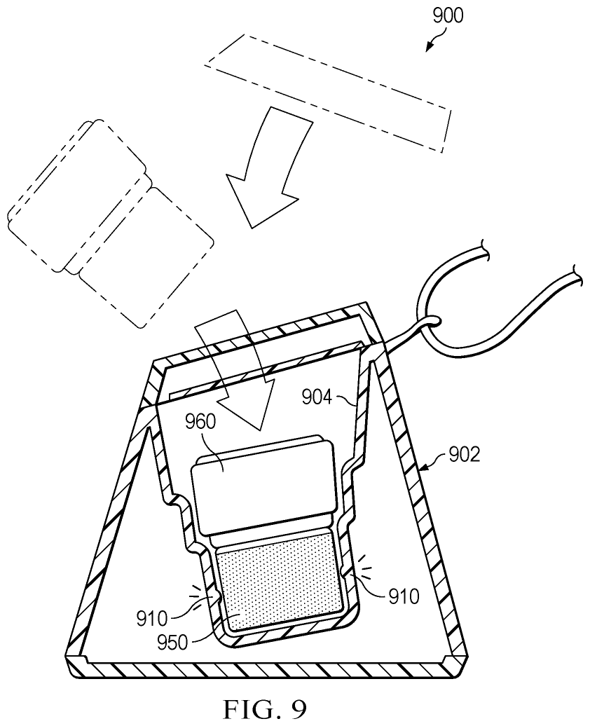

Referring now to FIG. 9, a side cutaway view of another embodiment of insect repellent system 900 according to aspects of the present disclosure is shown. The system 900 comprises a housing 902 defining a cavity 904 for receiving a gel repellent pack 960 and an exothermic heater pack 950. The gel repellent pack 960 may be integrated with, or separate from, the exothermic heater pack 950. Protrusions 910 may be provided in the cavity 904 that puncture the exothermic heater pack 950 when it is placed in the cavity. The heat from the exothermic heater pack 950 may then volatize the repellent in the repellent pack 960.

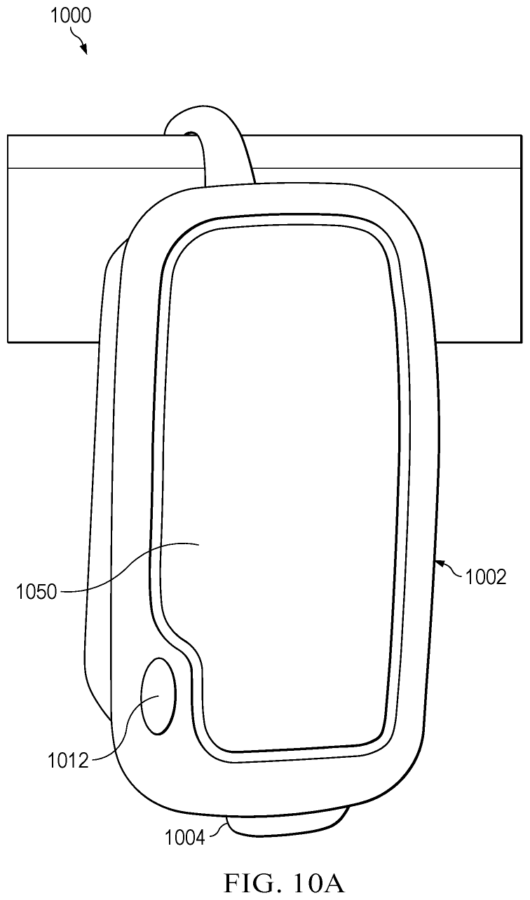

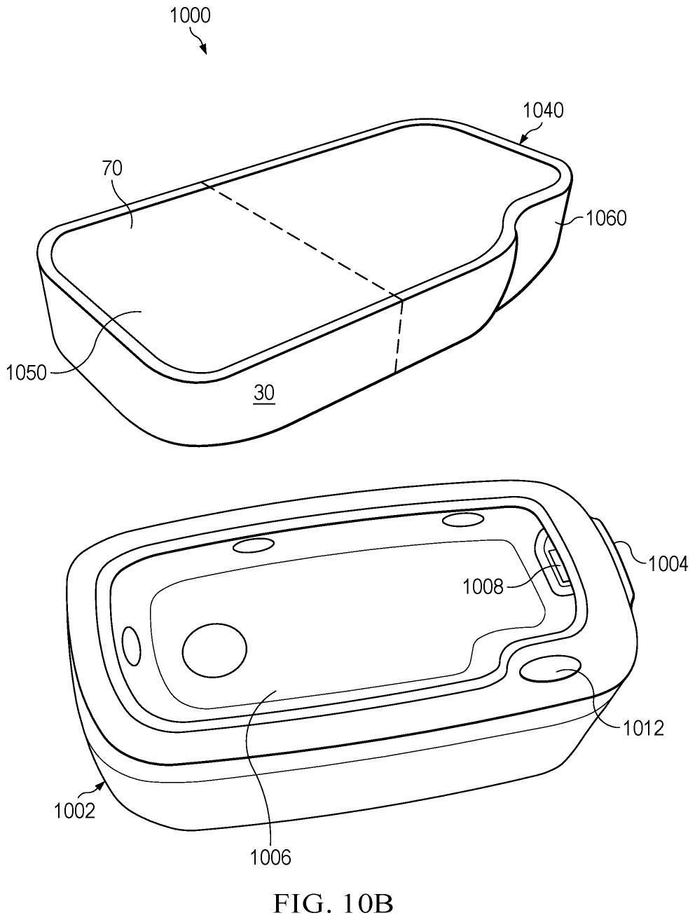

Referring now to FIG. 10A, a perspective view of another embodiment of an insect repellent system 1000 according to aspects of the present disclosure is shown. FIG. 10B is an exploded perspective view of the insect repellent system 1000 of FIG. 10A. The system 1000 comprises a housing 1002 defining a cavity 1006 that receives a self-heating gel repellent insert 1040.

The insert 1040 may snap or press fit in and out of the cavity 1006. The insert may comprise a gel repellent portion 1050, possibly containing insect repellent gel carrier 30 retained by polymer film 70. The gel repellent portion 1050 may be affixed or mated to a self-heating portion 1060 containing reactants that undergo an exothermic reaction when exposed to air.

The insert 1040 may be fitted into the cavity 1006 but remain inert or non-active until the self-heating portion of the insert 1040 is punctured by cutter 1008 that may be activated by pressing external button 1004. A color change indicator 1012 may provide visual cues that the repellent system 1000 is active.

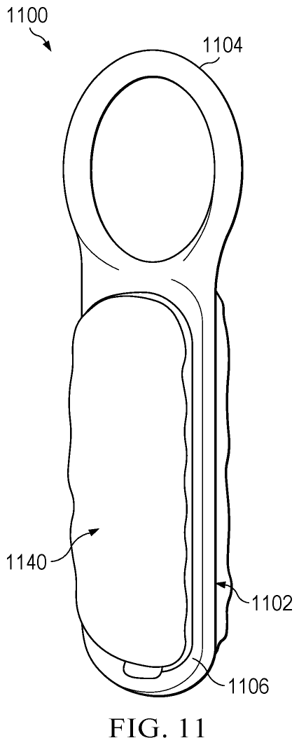

Referring now to FIG. 11 is a perspective view of another embodiment of an insect repellent system 1100 according to aspects of the present disclosure is shown. The system 1100 comprises a hanger 1102 having a lower receptacle 1106 that accepts a self-heating gel repellent insert 1140. The self-heating gel repellent insert may comprise a repellent carrier gel as discussed above. A self-heating portion may rely on any of the self-heating technologies discussed herein or otherwise known in the art. The self-heating reaction may be activated manually before or after the insert 1140 is placed in the receptacle (e.g., by perforating a container or mixing required ingredients). A handle 1104, hook, and/or other convenience features may be provided as part of the hanger 1102.

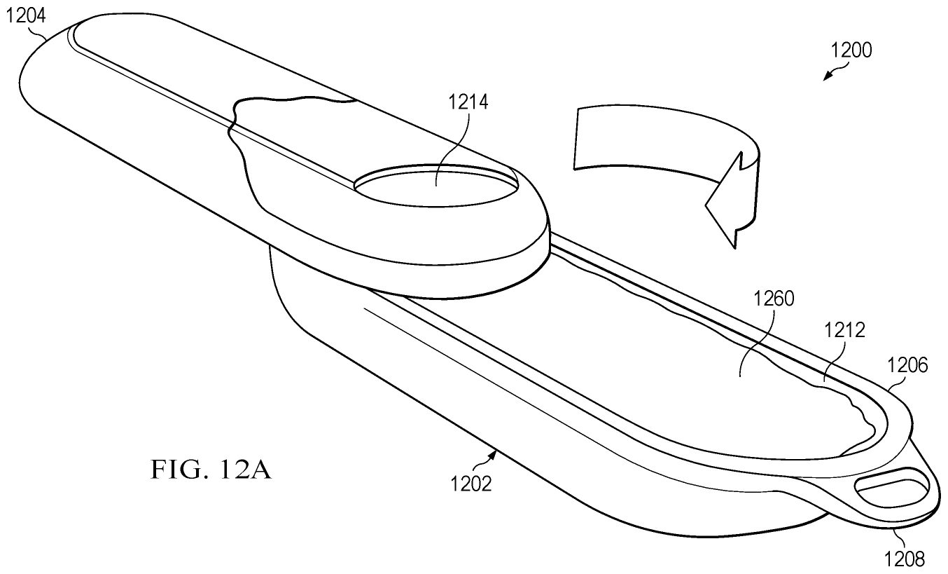

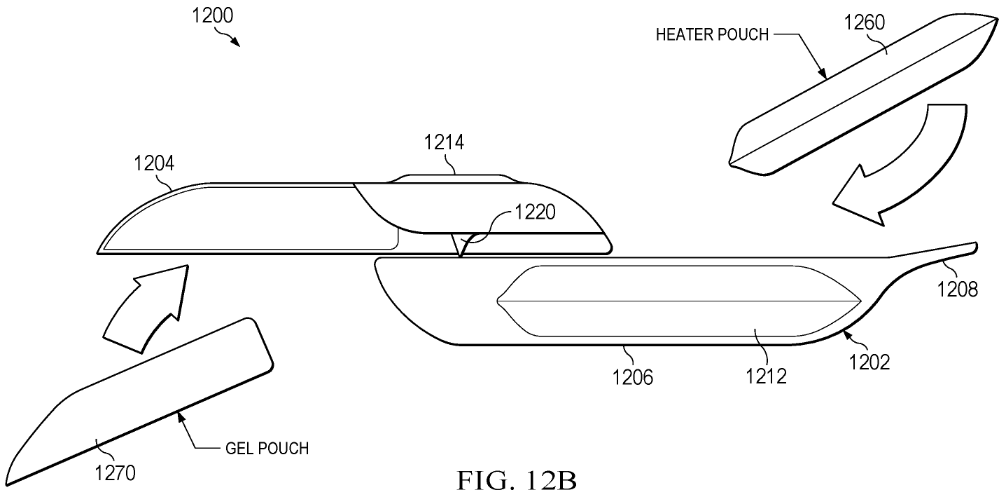

Referring now to FIG. 12A a perspective view of another embodiment of an insect repellent system 1200 according to aspects of the present disclosure is shown. FIG. 12B is a side cutaway view of the insect repellent system 1200. The system 1200 comprises a housing comprising an upper housing 1204 and a lower housing 1206. The housing 1200 opens and closes by rotation of the upper housing 1204 relative to the lower housing 1206.

The lower housing 1206 may retain an exothermic heat pack 1212 while a gel repellent pack 1270 is stored in the upper housing 1204. When the housing 1202 is closed, the exothermic heat pack 1260 lies adjacent to the gel repellent pack 1270. An activation button 1214 may be provided that drives a piercing member 1220 into the exothermic heat pack 1260 to begin the heating reaction. The heat pack 1260 may be activated by allowing air into the internal reactants, by piercing an internal bladder allowing fluid activation, etc.

The housing 1202 may be retained closed by friction of the rotating connection between upper housing 1204 and lower housing 1206, by an interference fit, by a latch, or another mechanism. A handle 1208 and/or other convenience features may be provided on the housing 1202.

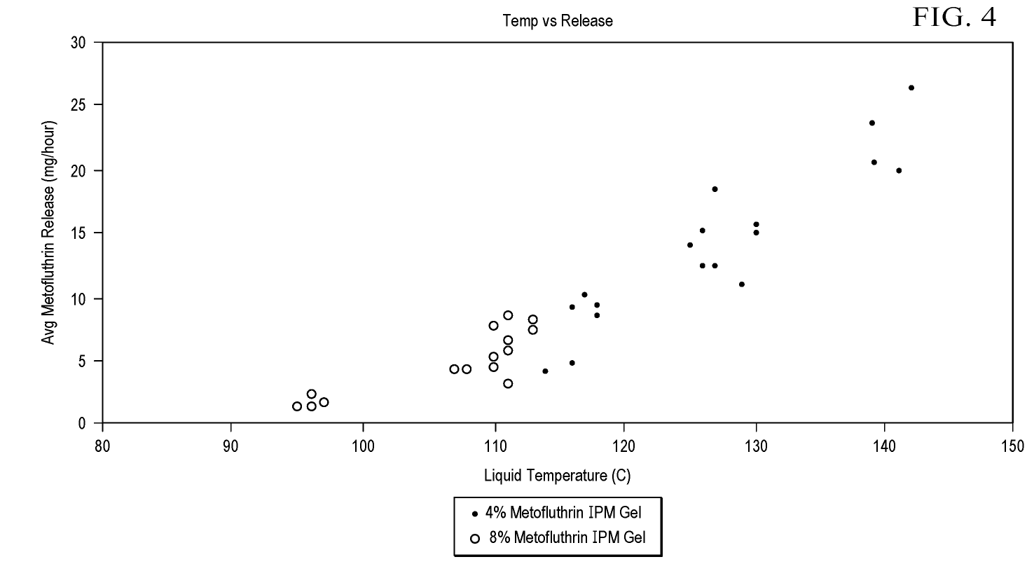

It should be understood that the exothermic heater packs and gel repellent packs of FIGS. 6A-12B may function similarly or identically, and have similar or identical components, as the corresponding components of the self-heating repellent insert 550 of FIG. 5 and/or the gel repellent container 10 of FIGS. 1-4.

It should also be understood that some embodiments are described with respect to use of an exothermic reaction taking place upon exposure to air. Therefor protrusions or device to puncture the heater pack may be utilized. However, certain exothermic heater packs may be punctured or otherwise opened manually before being inserted into the respective repellent device or system. Additionally, where the exothermic reaction utilizes water or a combination of liquid reactants, these may be combined manually prior to being inserted into the respective repellent device or system.

Additionally, although particular embodiments are described as utilizing repellents such as metofluthrin to be volatilized from phase changing gel carriers of the present disclosure, other known repellents and delivery structures may be used. For example, mats, wicks, beads, porous materials, and other structures may be to disperse other known repellents via heating from exothermic heating packs within systems or methods of the present disclosure.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system comprising:
a housing;
an exothermic heater pack; and
a gel carrier infused with an insect repellent;
wherein the housing retains the exothermic heater pack in sufficient proximity to the gel carrier infused with repellent that the repellent volatilizes from the gel carrier.

2. The system of claim 1, wherein the insect repellent comprises metofluthrin.

3. The system of claim 1, wherein the gel carrier comprises isopropyl myristate.

4. The system of claim 1, wherein the exothermic heater pack contains a composition that produces heat upon exposure to air.

5. The system of claim 1, wherein the exothermic heater pack contains a composition that produces heat upon exposure to water.

6. The system of claim 1, wherein the exothermic heater pack contains two substances that produce heat when combined.

7. The system of claim 1, wherein the exothermic heater pack is integral with the gel carrier.

8. The system of claim 7, wherein the housing comprises an upper housing portion and a lower housing portion that receives the exothermic heater pack integrated with the gel carrier.

9. The system of claim 8, wherein the upper housing portion opens from the lower housing portion to receive the exothermic heater pack integrated with the gel carrier, and contains a protrusion that punctures the exothermic heater pack when the housing is closed.

10. The system of claim 1, further comprising a color changing heat indicator on the housing.

11. A self-heating gel repellent insert comprising:
a first compartment containing a repellent gel carrier containing an insect repellent that volatilizes from the gel carrier when heated;
a second compartment containing a chemical based exothermic reactant for heating the gel carrier.

12. The self-heating gel repellent insert of claim 11, wherein the chemical based exothermic reactant produces heat upon exposure to air.

13. The self-heating gel repellent insert of claim 12, wherein the second compartment is punctured to activate the chemical based exothermic reactant.

14. The self-heating gel repellent insert of claim 11, wherein the gel repellent carrier comprises isopropyl myristate.

15. The self-heating gel repellent insert of claim 14, wherein the repellent comprises metofluthrin.

16. An insect repellent system comprising:
a housing;
a repellent contained in the housing, the repellent being volatilized by application of heat; and
a chemical heater contained in the housing proximate the repellent.

17. The insect repellent system of claim 16, wherein the repellent contained in the housing is imbued into a gel carrier having a first gel phase and a second liquid phase, the gel carrier releasing the repellent when in the second liquid phase.

18. The insect repellent system of claim 17, wherein the gel carrier comprises isopropyl myristate.

19. The insect repellent system of claim 18, wherein the gel carrier is retained within the housing by a polymer film.

20. The insect repellent system of claim 18, wherein the housing has a first open position and a second closed position, and the housing mechanically activates the chemical heater by puncturing it when placed in the second closed position.
